(19) United States
(12) Patent Application Publication
(10) Pub. No.: US 2018/0298560 A1
(43) Pub. Date: Oct. 18, 2018

(54) PATTERNED TISSUE HAVING A NEGATIVE POISSONS RATIO

(71) Applicant: Kimberly-Clark Worldwide, Inc., Neenah, WI (US)

(72) Inventors: Mark Alan Burazin, Oshkosh, WI (US); Mike Thomas Goulet, Neenah, WI (US); Jeffrey Dean Holz, Sherwood, WI (US); Mark William Sachs, Appleton, WI (US); Kevin Joseph Vogt, Neenah, WI (US); Kenneth John Zwick, Neenah, WI (US); Tara Marie Logut, Coraopolis, PA (US)

(21) Appl. No.: 15/768,051

(22) PCT Filed: Oct. 13, 2016
(86) PCT No.: PCT/US2016/056772

§ 371 Date: Apr. 13, 2018

Related U.S. Application Data
(60) Provisional application No. 62/242,582, filed on Oct. 16, 2015.

(51) Int. Cl. D21H 27/02; D21H 27/00; B31F 1/07

(52) U.S. Cl. CPC D21H 27/02; B31F 1/07; D21H 27/004

(57) ABSTRACT

The present invention relates to tissue webs and products having a topographical pattern comprising a plurality of substantially machine direction orientated line elements disposed on at least one surface of the tissue web. Preferably the line elements having an element angle (α), measured relative to the machine direction axis, from about 1 to about 20 degrees resulting in a tissue web having a Poisson's ratio from about 0 to about −0.60 and more preferably from about −0.10 to about −0.50 and still more preferably from about −0.20 to about −0.40. In addition to having a negative Poisson's ratio, the inventive tissue webs have desirable cross-machine direction properties, such as high CD Stretch and high CD TEA at relatively modest Tensile Ratios.

### BACKGROUND

Tissue webs, such as tissue webs and products, are generally manufactured by wet laying a slurry of papermaking fibers on a forming belt traveling at high rates of speed, which causes the fibers to orient in the machine direction. As such the resulting web often has distinct machine and cross-machine physical properties, with the cross-machine properties often being less desirable than the machine direction properties. Thus, tissue makers are constantly trying to improve the cross-machine properties of wet laid tissue webs such as tissue webs and products. For example, tissue makers have attempted to apply bonding materials in a pattern to enhance the strength and stretch properties of the web in the cross-machine direction without similarly increasing the same properties of the web in the machine direction.

Not only do wet-laid tissue webs often have cross-machine direction properties that are deficient to machine direction properties, they often have relatively high Poisson's ratios. When a structure having a positive Poisson's ratio is strained in the machine direction, the width of the structure in the cross-machine direction decreases. Since tissue webs are typically strained in the machine direction during formation and converting the effect of a positive Poisson's ratio must be compensated for and/or controlled. This can add complexity and cost to the manufacturing process.

As such, a need currently exists for tissue webs having improved cross-machine properties. In particular, a need currently exists for an improved tissue web having a negative Poisson's ratio. Structures having a negative Poisson's ratio increase in width when strained in the lengthwise direction improving operating efficiency and the properties of the finished product.

### SUMMARY

The present inventors have now discovered a means of modulating the Poisson's ratio of a tissue web by imparting the structure with a topographical pattern comprising a plurality of substantially machine direction orientated line elements. Preferably the line elements have an element angle from about 1 to about 20 degrees resulting in a tissue web having a negative Poisson's ratio, such as from about 0 to about −0.60 and more preferably from about −0.10 to about −0.50 and still more preferably from about −0.20 to about −0.40. In addition to having a negative Poisson's ratio, the inventive tissue webs have desirable cross-machine direction properties, such as high CD Stretch and high CD TEA at relatively modest Tensile Ratios. These and other improvements result in structures that are visually appealing, have well balanced machine and cross-machine direction properties and are well suited for handling throughout the manufacturing and converting process.

Accordingly, in one embodiment the present invention provides tissue webs and products having a CD Stretch greater than about 8.0 percent, a CD TEA greater than about 4.0 g*cm/cm², a Tensile Ratio less than about 2.5, and more preferably less than about 2.0, and a Poisson's Ratio less than about 0, such as from about −0.10 to about −0.50.

In another embodiment the present invention provides tissue webs and products having a topographical pattern comprising a plurality of substantially machine direction orientated line elements disposed on at least one surface thereof, the line elements having an element angle from about 1 to about 20 degrees, the tissue web having a Poisson's ratio from about 0 to about −0.60.

In still another embodiment the present invention provides tissue webs and products having a topographical pattern comprising from about 2 to about 4 line elements per centimeter in the cross-machine direction, the line elements having an element angle from about 8 to about 12 degrees and the web having a Poisson's ratio from about −0.20 to about −0.40.

In yet another embodiment the present invention provides a tissue product comprising a wet-molded topographical pattern comprising from about 2 to about 4 line elements per centimeter in the cross-machine direction, the line elements having an element angle from about 8 to about 12 degrees and the product having a Poisson's ratio from about −0.20 to about −0.40.

### DESCRIPTION OF THE DRAWINGS

FIG. 1 is a view of a fabric useful in the manufacture of tissue webs according to one embodiment of the present invention;

FIG. 2 is top perspective view of a fabric useful in the manufacture of tissue webs according to one embodiment of the present invention;

FIG. 3 is a cross section view of a fabric useful in the manufacture of tissue webs according to one embodiment of the present invention taken through line 3-3 of FIG. 2;

FIG. 4 is a perspective view of a tissue web according to one embodiment of the present invention;

FIG. 5 is a cross section view of the tissue web of FIG. 4 through line 5-5;

FIG. 6 is a top planar view of a tissue web according to one embodiment of the present invention;

FIG. 7 is a top planar view of a tissue web according to another embodiment of the present invention;

FIG. 7B is a detailed illustration of the unit cell of FIG. 7 defined by ABCD.

FIG. 8 is a top planar view of a tissue web according to still another embodiment of the present invention; and

FIG. 9 is a top planar view of a tissue web according to another embodiment of the present invention.

### DEFINITIONS

As used herein the term “tissue web” refers to a structure comprising a plurality of elongated particulates having a length to diameter ratio greater than about 10 such as, for example, papermaking fibers and more particularly pulp fibers, including both wood and non-wood pulp fibers, and synthetic staple fibers. A non-limiting example of a tissue web is a wet-laid sheet material comprising pulp fibers.

As used herein the term “tissue product” refers to products made from tissue webs and includes, bath tissues, facial tissues, paper towels, industrial wipers, foodservice wipers, napkins, medical pads, and other similar products. Tissue products may comprise one, two, three or more plies.

As used herein the term “ply” refers to a discrete tissue web used to form a tissue product. Individual plies may be arranged in juxtaposition to each other.

As used herein the term “layer” refers to a plurality of strata of fibers, chemical treatments, or the like within a ply.

As used herein the “topographical pattern” generally refers to a pattern disposed on at least one surface of the tissue web in accordance with the present invention. The topographical pattern generally texturizes the surface of the tissue web providing the surface with a first and a second elevation. The topographical pattern may comprise a plurality of line elements, such as a plurality of line elements that are substantially oriented in the machine direction of the tissue web.

As used herein the term “line element” refers to a topographical pattern in the shape of a line, which may be a continuous, discrete, interrupted, and/or partial line with respect to a tissue web on which it is present. The line element may be of any suitable shape such as straight, bent, kinked, curled, curvilinear, serpentine, sinusoidal, and mixtures thereof that may form regular or irregular periodic or non-periodic lattice work of structures wherein the line element exhibits a length along its path of at least 10 mm. In one example, the line element may comprise a plurality of discrete elements, such as dots and/or dashes for example, that are oriented together to form a line element.

As used herein the term “continuous element” refers to an element disposed on a carrier structure useful in forming a tissue web or a topographical pattern that extends without interruption throughout one dimension of the carrier structure or the tissue web.

As used herein the term “discrete element” refers to separate, unconnected elements disposed on a carrier structure useful in forming a tissue web or on the surface of a tissue web that do not extend continuously in any dimension of the support structure or the tissue web as the case may be.

As used herein the term “curvilinear decorative element” refers to any line or visible pattern that contains either straight sections, curved sections, or both that are substantially connected visually. Curvilinear decorative elements may appear as undulating lines, substantially connected visually, forming signatures or patterns.

As used herein “decorative pattern” refers to any non-random repeating design, figure, or motif. It is not necessary that the curvilinear decorative elements form recognizable shapes, and a repeating design of the curvilinear decorative elements is considered to constitute a decorative pattern.

As used herein the term “basis weight” generally refers to the bone dry weight per unit area of a tissue and is generally expressed as grams per square meter (gsm). Basis weight is measured using TAPPI test method T-220. While basis weight may be varied, tissue products prepared according to the present invention generally have a basis weight greater than about 30 gsm, such as from about 30 to about 60 gsm and more preferably from about 40 to about 50 gsm.

As used herein the term “caliper” is the representative thickness of a single sheet (caliper of tissue products comprising two or more plies is the thickness of a single sheet of tissue product comprising all plies) measured in accordance with TAPPI test method T402 using an EMVECO 200-A Microgage automated micrometer (EMVECO, Inc., Newberg, Oreg.). The micrometer has an anvil diameter of 2.22 inches (56.4 mm) and an anvil pressure of 132 grams per square inch (per 6.45 square centimeters) (2.0 kPa). The caliper of a tissue product may vary depending on a variety of manufacturing processes and the number of plies in the product, however, tissue products prepared according to the present invention generally have a caliper greater than about 500 μm, more preferably greater than about 575 μm and still more preferably greater than about 600 μm, such as from about 500 to about 1,000 μm and more preferably from about 600 to about 750 μm.

As used herein the term “sheet bulk” refers to the quotient of the caliper (generally having units of μm) divided by the bone dry basis weight (generally having units of gsm). The resulting sheet bulk is expressed in cubic centimeters per gram (cc/g). Tissue products prepared according to the present invention generally have a sheet bulk greater than about 8 cc/g, more preferably greater than about 10 cc/g and still more preferably greater than about 12 cc/g, such as from about 8 to about 20 cc/g and more preferably from about 12 to about 18 cc/g.

As used herein, the terms “geometric mean tensile” and “GMT” refer to the square root of the product of the machine direction tensile strength and the cross-machine direction tensile strength of the tissue product. While the GMT may vary, tissue products prepared according to the present invention generally have a GMT greater than about 700 g/3″, more preferably greater than about 750 g/3″ and still more preferably greater than about 800 g/3″, such as from about 700 to about 1200 g/3″.

As used herein, the term “stretch” generally refers to the ratio of the slack-corrected elongation of a specimen at the point it generates its peak load divided by the slack-corrected gauge length in any given orientation. Stretch is an output of the MTS TestWorks™ in the course of determining the tensile strength as described in the Test Methods section herein. Stretch is reported as a percentage and may be reported for machine direction stretch (MDS), cross-machine direction stretch (CDS) or as geometric mean stretch (GMS), which is the square root of the product of machine direction stretch and cross-machine direction stretch.

As used herein, the term “slope” refers to slope of the line resulting from plotting tensile versus stretch and is an output of the MTS TestWorks™ in the course of determining the tensile strength as described in the Test Methods section herein. Slope is reported in the units of grams (g) per unit of sample width (inches) and is measured as the gradient of the least-squares line fitted to the load-corrected strain points falling between a specimen-generated force of 70 to 157 grams (0.687 to 1.540 N) divided by the specimen width. Slopes are generally reported herein as having units of grams (g) or kilograms (kg).

As used herein, the term “geometric mean slope” (GM Slope) generally refers to the square root of the product of machine direction slope and cross-machine direction slope. GM Slope generally is expressed in units of kilograms (kg). While the GM Slope may vary, tissue products prepared according to the present invention generally have a GM Slope less than about 6.5 kg, more preferably less than about 5.5 kg and still more preferably less than about 5.0 kg, such as from about 4.5 to about 6.5 kg.

As used herein, the term “Stiffness Index” refers to GM Slope (having units of kg), divided by GMT (having units of g/3″) multiplied by 1,000. While the Stiffness Index may vary, tissue products prepared according to the present invention generally have a Stiffness Index less than about 7.5, more preferably less than about 7.0 and still more preferably less than about 6.0 such as from about 5.0 to about 7.5.

As used herein the term “Poisson's ratio” refers to the ratio of transverse contraction strain to longitudinal extension strain in the direction of a stretching force. Tensile deformation is considered positive and compressive deformation is considered negative. The mathematical expression of a Poisson's ratio for a material contains a minus sign so that normal materials have a positive ratio. In other words, since most common materials decrease in width when stretched in a lengthwise direction, the Poisson's ratio for these materials is positive. Tissue webs of the present invention on the other hand generally have a Poisson's ratio less than 0, such that the structure increases in width when stretched in a lengthwise direction. The Poisson's ratio of a tissue web is measured as described in the test methods section below.

### DETAILED DESCRIPTION

The present invention provides a variety of novel tissue webs having a topographical pattern disposed on at least one surface. When a pattern of the present invention is incorporated into a tissue web the pattern causes the material to resist deformation and shrinkage in the cross-machine direction when the material is pulled in the machine direction. As a result the tissue webs of the present invention generally have a negative Poisson's ratio, such as a Poisson's ratio from about −0.60 to about 0. Without being bound by any particular theory it is hypothesized that the topographical pattern disposed on the tissue web is such that when the tissue web is elongated in the machine direction the pattern expands causing the tissue web to expand in the cross-machine direction. In this manner, the pattern may be considered to comprise a plurality of auxetic cells, which expand in the cross-machine direction when subjected to machine direction strain.

Tissue webs, such as those disclosed herein, exhibiting a negative Poisson's ratio may display improved product properties such as increased CD stretch and increased CD TEA. Care must be taken however, to ensure that the Poisson's ratio does not become so negative that converting and handling of tissue webs during manufacture is compromised. Accordingly, tissue webs and products prepared according to the present invention generally have a Poisson's ratio from about 0 to about −0.60 and more preferably from about −0.10 to about −0.40 and still more preferably from about −0.20 to about −0.30. Tissue products having the foregoing Poisson's ratio generally have good inter-fiber bonding and have geometric mean tensile strengths greater than about 700 g/3″, such as from about 700 to about 1,200 g/3″ and more preferably from about 800 to about 1,000 g/3″ while having basis weights greater than about 30 gsm, such as from about 30 to about 60 and more preferably from about 35 to about 45 gsm.

Generally the tissue webs of the present invention comprise a topographical pattern, and more specifically a topographical pattern, on at least one of its surfaces. Preferably the pattern is imparted during the manufacturing process such as by wet texturing during formation of the web, molding the pattern into the web using a drying fabric or by embossing. The pattern is not the result of printing, which generally would not result in a three dimensional topographical pattern. As such the tissue webs of the present invention are generally free from bonding materials applied to the surface by printing or the like. Further, tissue webs of the present invention are generally produced without the use of latex bonding materials such as acrylates, vinyl acetates, vinyl chlorides and methacrylates. Rather than having printed patterns the instant tissue webs have patterns that are formed by embossing, wet molding and/or through-air drying via an embossing roll, a fabric and/or an imprinted through-air drying fabric.

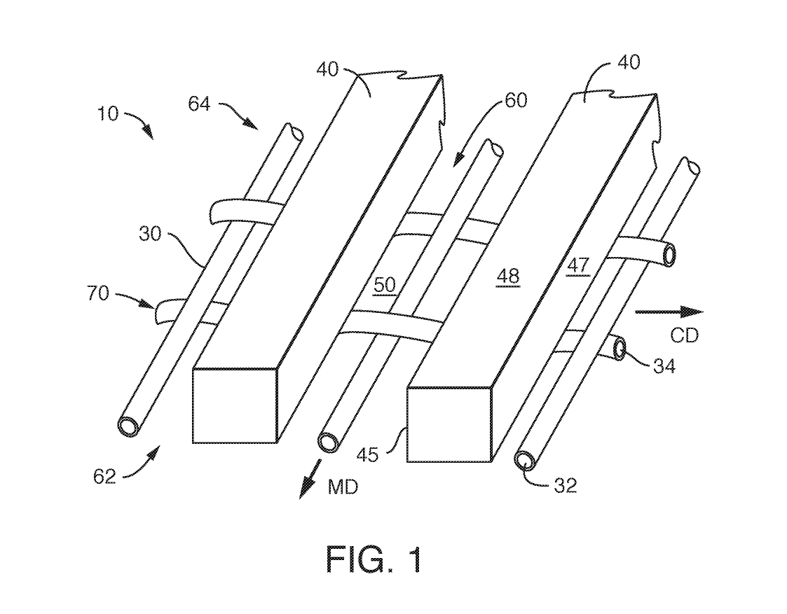

Accordingly, in one embodiment, the topographical pattern is formed during the manufacturing process by molding the tissue web using an endless belt having a corresponding topographical pattern. For example, as illustrated in FIG. 1, the tissue web may be manufactured using an endless belt 10 comprising a continuous three dimensional element 40, also referred to simply as a continuous line element, and a reinforcing structure 30 (also referred to herein as a carrier structure or fabric). The reinforcing structure 30 comprises a pair of opposed major surfaces—a web contacting surface 64 from which the continuous line elements 40 extend and a machine contacting surface 62. Machinery employed in a typical papermaking operation is well known in the art and may include, for example, vacuum pickup shoes, rollers, and drying cylinders. In one embodiment the belt comprises a through-air drying fabric useful for transporting an embryonic tissue web across drying cylinders during the tissue manufacturing process. In such embodiments the web contacting surface 64 supports the embryonic tissue web, while the opposite surface, the machine contacting surface 62, contacts the through-air dryer.

Generally the continuous line element 40 is disposed on the web-contacting surface 64 for cooperating with, and structuring of, the wet fibrous web during manufacturing. In a particularly preferred embodiment the web contacting surface 64 comprises a plurality of spaced apart three dimensional elements distributed across the web-contacting surface 64 of the carrier structure 50 and together constituting from at least about 15 percent of the web-contacting surface, such as from about 15 to about 35 percent, more preferably from about 18 to about 30 percent, and still more preferably from about 20 to about 25 percent of the web-contacting surface.

In addition to continuous line elements 40 the web-contacting surface 64 preferably comprises a plurality of continuous landing areas 60. The landing areas 60 are generally bounded by the elements 40 and coextensive with the top surface plane 50 of the belt 10. Landing areas 60 are generally permeable to liquids and allow water to be removed from the cellulosic tissue web by the application of differential fluid pressure, by evaporative mechanisms, or both when drying air passes through the embryonic tissue web while on the papermaking belt 10 or a vacuum is applied through the belt 10. Without being bound by any particularly theory, it is believed that the arrangement of elements and landing areas allow the molding of the embryonic web causing fibers to deflect in the z-direction and generate the caliper of, and patterns on the resulting tissue web.

The carrier structure 30 has two principle dimensions—a machine direction (“MD”), which is the direction within the plane of the belt 10 parallel to the principal direction of travel of the tissue web during manufacture and a cross-machine direction (“CD”), which is generally orthogonal to the machine direction. The carrier structure 30 is generally permeable to liquids and air. In one particularly preferred embodiment the carrier structure is a woven fabric. The carrier structure may be substantially planar or may have a three dimensional surface defined by ridges. In one embodiment the carrier structure is a substantially planar woven fabric such as a multi-layered plain-woven fabric 30 having base warp yarns 32 interwoven with shute yarns 34 in a 1×1 plain weave pattern. One example of a suitable substantially planar woven fabric is disclosed in U.S. Pat. No. 8,141,595, the contents of which are incorporated herein in a manner consistent with the present invention. In a particularly preferred embodiment, the carrier structure comprises a substantially planar woven fabric wherein the plain-weave load-bearing layer is constructed so that the highest points of both the load-bearing shutes 34 and the load-bearing warps 32 are coplanar and coincident with the plane 70.

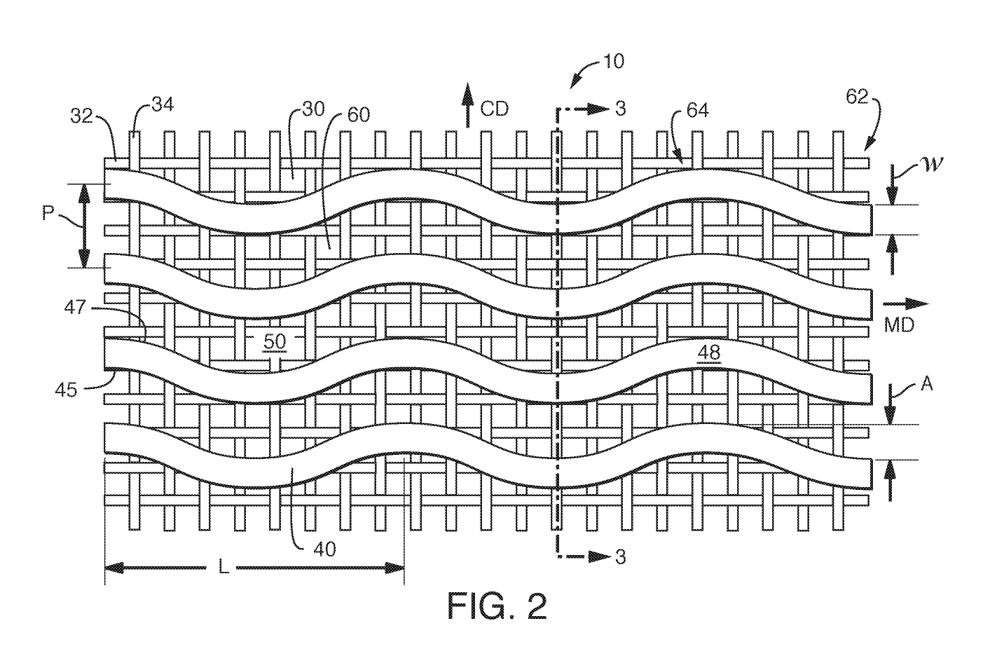

With further reference to FIGS. 1 and 2 a plurality of continuous elements 40 are disposed on the web-contacting surface 64 of the carrier structure 30. Each element 40 has a first dimension in a first direction (x) in the plane of the top surface area, a second dimension in a second direction (y) in the plane of the top surface area, the first and second directions (x, y) being at right angles to each other. The extent of the element 40 in the first direction (x) generally defines the element width (w). The continuous element 40 further comprises a top surface area 48 extending substantially along the second direction (y) and a pair of opposed sidewalls 45, 47 extending in the z-direction and having a mean height (h). These dimensions being defined when the belt is in an uncompressed state.

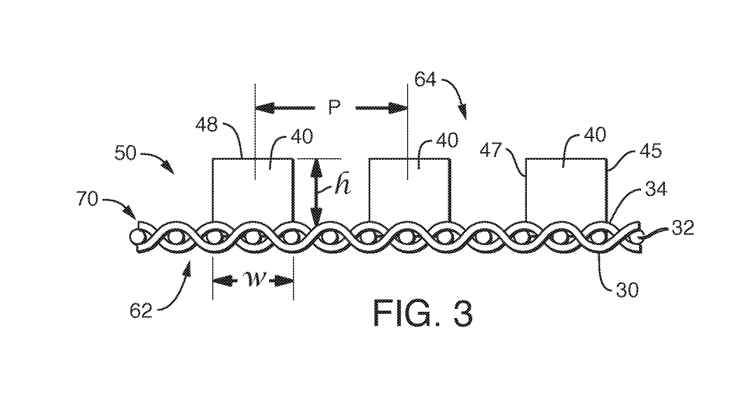

The continuous elements 40 generally extend in the z-direction (generally orthogonal to both the machine direction and cross-machine direction) above the plane 70 of the carrier structure 30. The elements may have straight sidewalls or tapered sidewalls and be made of any material suitable to withstand the temperatures, pressures, and deformations which occur during the papermaking process. In the embodiment illustrated in FIG. 3 the continuous elements 40 are similarly sized and have generally straight, parallel sidewalls 45, 47 providing the continuous elements 40 with a width (w), and a height (h). The width (w) and the height (h) may be varied depending on the desired degree of molding and the resulting tissue product properties. In certain embodiments the height (h) is greater than about 0.5 mm, such as from about 0.5 and 3.5 mm, more preferably from about 0.5 to about 1.5 mm, and in a particularly preferred embodiment between from about 0.7 to about 1.0 mm. The height (h) is generally measured as the distance between the plane of the carrier structure and the top plane of the elevations.

Further, the continuous elements 40 may have a width (w) greater than about 0.5 mm, such as from about 0.5 to about 3.5 mm, more preferably from about 0.5 to about 2.5 mm, and in a particularly preferred embodiment between from about 0.7 to about 1.5 mm. The width is generally measured normal to the principal dimension of the elevation within the plane of the belt at a given location. Where the element 40 has a generally square or rectangular cross-section, the width (w) is generally measured as the distance between the two planar sidewalls 45, 47 that form the element 40. In those cases where the element does not have planar sidewalls, the width is measured along the base of the element at the point where the element contacts the carrier.

In a particularly preferred embodiment the continuous elements 40 have planar sidewalls 45, 47 such that the cross-section of the element has an overall square or rectangular shape. However, it is to be understood that the design element may have other cross-sectional shapes, such as triangular, convex or concave, which may also be useful in producing high bulk tissue products according to the present invention. Accordingly, in a particularly preferred embodiment the continuous elements 40 preferably have planar sidewalls 45, 47 and a square cross-section where the width (w) and height (h) are equal and vary from about 0.5 and 3.5 mm, more preferably from about 0.5 to about 1.5 mm, and in a particularly preferred embodiment between from about 0.7 to about 1.0 mm.

The spacing and arrangement of continuous elements may vary depending on the desired tissue product properties and appearance. In one embodiment a plurality of elements extend continuously throughout one dimension of the belt and each element in the plurality is spaced apart from the adjacent element. Thus, the elements may be spaced apart across the entire cross-machine direction of the belt, may endlessly encircle the belt in the machine direction, or may run diagonally relative to the machine and cross-machine directions. Of course, the directions of the elements alignments (machine direction, cross-machine direction, or diagonal) discussed above refer to the principal alignment of the elements. Within each alignment, the elements may have segments aligned at other directions, but aggregate to yield the particular alignment of the entire elements.

Generally the elements are spaced apart from one another so as to define a landing area there-between. In use, as the embryonic tissue web is formed fibers are deflected in the z-direction by the continuous elements, however, the spacing of elements is such that the web maintains a relatively uniform density. This arrangement provides the benefits of improved web extensibility, increased sheet bulk, better softness, and a more pleasing texture.

If the individual elements are too high, or the landing area is too small, the resulting sheet may have excessive pinholes and insufficient compression resistance, CD stretch, and CD TEA, and be of poor quality. Further, tensile strength may be degraded if the span between elements greatly exceeds the fiber length. Conversely, if the spacing between adjacent elements is too small the tissue will not mold into the landing areas without rupturing the sheet, causing excessive sheet holes, poor strength, and poor paper quality.

In addition to varying the spacing and arrangement of the elements along the carrier structure, the shape of the element may also be varied. For example, in one embodiment, the elements are substantially sinusoidal and are arranged substantially parallel to one another such that none of the elements intersect one another. As such, in the illustrated embodiment, the adjacent sidewalls of individual elements are equally spaced apart from one another. In such embodiments, the center-to-center spacing of design elements (also referred to herein as pitch or simply as p) may be greater than about 1.0 mm, such as from about 1.0 to about 20 mm apart and more preferably from about 2.0 to about 10 mm apart. In one particularly preferred embodiment the continuous elements are spaced apart from one-another from about 3.8 to about 4.4 mm apart. This spacing will result in a tissue web which generates maximum caliper when made of conventional cellulosic fibers. Further, this arrangement provides a tissue web having three dimensional surface topography, yet relatively uniform density.

In other embodiments the continuous elements may occur as wave-like patterns that are arranged in-phase with one another such that the pitch (p) is approximately constant. In other embodiments elements may form a wave pattern where adjacent elements are offset from one another. Regardless of the particular element pattern, or whether adjacent patterns are in or out of phase with one another, the elements are separated from one another by some minimal distance. Preferably the distance between continuous elements is greater than 0.5 mm and in a particularly preferred embodiment greater than about 1.0 mm and still more preferably greater than about 2.0 mm such as from about 2.0 to about 6.0 mm and still more preferably from about 3.0 to about 4.5 mm.

Where the continuous elements are wave-like, the elements have an amplitude (A) and a wavelength (L). The amplitude may range from about 2.0 to about 200 mm, in a particularly preferred embodiment from about 10 to about 40 mm and still more preferably from about 18 to about 22 mm. Similarly, the wavelength may range from about 20 to about 500 mm, in a particularly preferred embodiment from about 50 to about 200 mm and still more preferably from about 80 to about 120 mm.

While in certain embodiments the elements are continuous the invention is not so limited. In other embodiments the elements may be discrete. For clarity, the discrete elements will be referred to herein as protuberances. Generally the protuberances are discrete and spaced apart from one another. Each protuberance is joined to a reinforcing structure and extends outwardly from the web contracting plane of the reinforcing structure. In this manner the protuberances contact the tissue web during manufacture.

The protuberances may have a square horizontal and lateral (relative to the plane of the carrier structure) cross-sectional shape, however, the shape is not so limited. The protuberance may have any number of different horizontal and lateral cross-sectional shapes. For example, the horizontal cross-section may have a rectangular, circular, oval, polygonal or hexagonal shape. A particularly preferred protuberance has planar sidewalls which are generally perpendicular to the plane of the carrier structure. Alternatively, the protuberances may have a tapered lateral cross-section formed by sides that converge to yield a protuberance having a base that is wider than the distal end.

The individual protuberances may be arranged in any number of different manners to create a decorative pattern. In one particular embodiment protuberances are spaced and arranged in a non-random pattern so as to create a wave-like design. In the illustrated embodiment spaced between the decorative patterns are landing areas that provide a visually distinctive interruption to the decorative pattern formed by the individual spaced apart protuberances. In this manner, despite being discrete elements, the protuberances are spaced apart so as to form a visually distinctive curvilinear decorative element that extends substantially in the machine direction. Taken as a whole the discrete elements forms a wave-like pattern.

In other embodiments the protuberances may be spaced and arranged so as to form a decorative figure, icon or shape such as a flower, heart, puppy, logo, trademark, word(s) and the like. Generally the design elements are spaced about the support structure and can be equally spaced or may be varied such that the density and the spacing distance may be varied amongst the design elements. For example, the density of the design elements can be varied to provide a relatively large or relatively small number of design elements on the web. In a particularly preferred embodiment the design element density, measured as the percentage of background surface covered by a design element, is from about 10 to about 35 percent and more preferably from about 20 to about 30 percent. Similarly the spacing of the design elements can also be varied, for example, the design elements can be arranged in spaced apart rows. In addition, the distance between spaced apart rows and/or between the design elements within a single row can also be varied.

In certain embodiments the plurality of protuberances defining a given design element may be spaced apart from one another so as to define landing areas there between. The landing areas are generally bounded by the designs and coextensive with the top surface plane of the carrier structure. Landing areas are generally permeable to liquids and allow water to be removed from the cellulosic tissue web by the application of differential fluid pressure, by evaporative mechanisms, or both when drying air passes through the embryonic tissue web while on the papermaking belt or a vacuum is applied through the belt.

The elements may be formed from a polymeric material, or other material, applied and joined to the carrier structure in any suitable manner. Thus in certain embodiments elements are formed by extruding, such as that disclosed in U.S. Pat. No. 5,939,008, the contents of which are incorporated herein by reference in a manner consistent with the present invention, or printing, such as that disclosed in U.S. Pat. No. 5,204,055, the contents of which are incorporated herein by reference in a manner consistent with the present invention, a polymeric material onto the carrier structure. In other embodiments the design element may be produced, at least in some regions, by extruding or printing two or more polymeric materials.

The above mentioned belts may be used in a variety of processes for the manufacture of tissue webs and products according to the present invention. For example, the tissue web can be a wet-creped web, a calendered web, an embossed web, a through-air dried web, a creped through-air dried web, an uncreped through-air dried web, as well as various combinations of the above. In one particular embodiment of the present invention, however, the tissue web is made in an uncreped through-air dried process. Uncreped through-air dried tissue webs may provide various advantages in the process of the present invention. It should be understood, however, that other types of tissue webs can be used in the present invention. For example, in an alternative embodiment, a wet creped tissue web can be utilized.

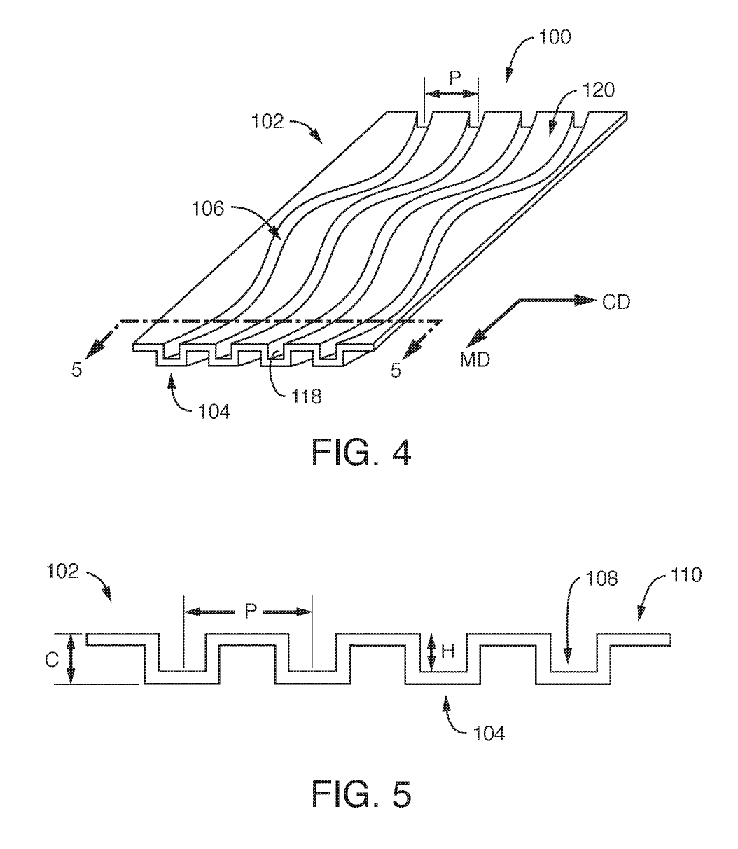

Tissue webs manufactured by one of the foregoing processes generally have a topographical pattern such as discrete line elements, continuous line elements that impart the tissue product with a negative Poisson's ratio and other improved physical properties. An exemplary tissue product is illustrated in FIG. 4, which shows a planar tissue product 100 having a machine (MD) and a cross-machine (CD) direction. The tissue product 100 has a first upper surface 102 and an opposed second lower surface 104. A wave-like topographical pattern 106 is disposed on the first upper surface 102. The wave-like topographical pattern 106 comprises a continuous line element substantially oriented in the machine direction (MD). The pattern generally consists of several wave-like elements 106 separated from one another by the planar surface 120 of the tissue web. While the illustrated wave-like topographical pattern 106 is continuous, in other embodiments the pattern may be semi-continuous or discontinuous.

The wave-like topographical pattern repeatedly crosses the machine direction axis to define an element angle (α). In the case of patterns having a wave-like shape such as illustrated in FIG. 4, the element angle (α) is generally the inverse tangent of the amplitude over half the wavelength. For other element shapes, such as continuous and discontinuous linear line elements, the element angle (α) may simply be measured relative to the machine direction axis. Preferably the element angle (α) is less than about 20 degrees, such as from about 1 to about 20 degrees and more preferably from about 5 to about 15 degrees and still more preferably from about 8 to about 12 degrees.

With reference to FIGS. 4 and 5, the wave-like topographical pattern 106 comprises a plurality of spaced apart continuous line elements 118. Each line element 118 forms an oscillating pattern or wave with alternating peaks 110 and valleys 108. The line elements 118 are arranged generally parallel to one another such that no two line elements insect one another. Further, in a preferred embodiment, the peaks 110 and valleys 108 of each element 118 and the valleys and peaks of each adjacent element are substantially in-phase with one another such that the spacing (P) between adjacent elements is substantially constant throughout the pattern 106. Generally the spacing (P) between adjacent elements is measured from the centers of adjacent peaks.

Accordingly, in certain embodiments, the spacing (P) may range from about 1.0 to about 10 mm, such as from about 2.0 to about 5.0 mm and more preferably from about 3.0 to about 4.5 mm. Further, the width (W) of the line elements 118 themselves may range from about 0.5 to about 5.0 mm, such as from about 0.75 to about 3.0 mm and more preferably from about 0.9 to about 1.5 mm. At the foregoing spacing and widths the tissue webs of the present invention generally comprise from about 2.0 to about 4.0 elements per centimeter in the cross-machine direction, more preferably from about 2.2 to about 3.5 line elements per centimeter and still more preferably from about 2.4 to about 3.0 line elements per centimeter.

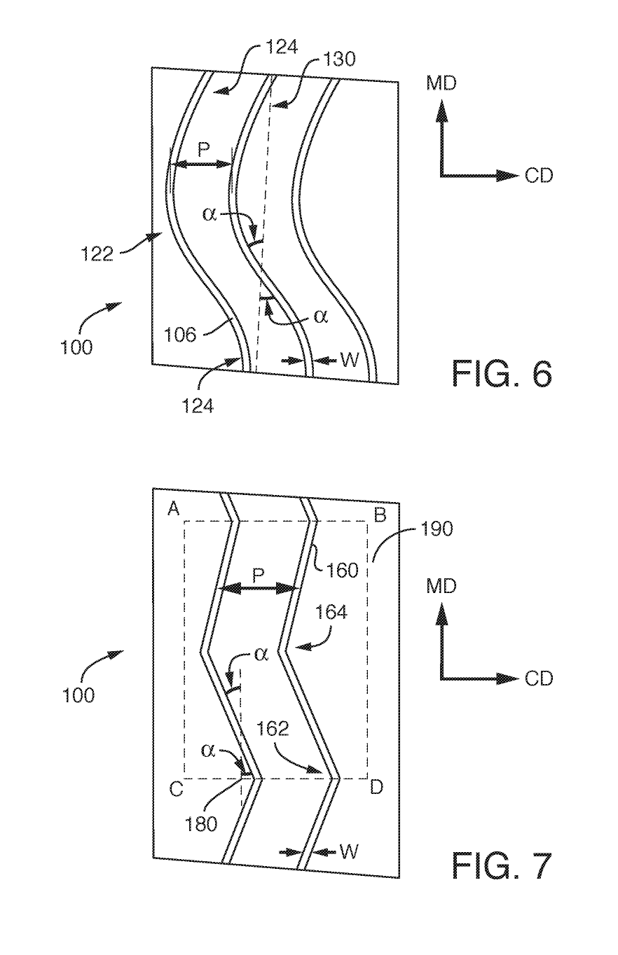

As the wave-like topographical pattern 106 alternates between wave peaks 122 and troughs 124 it repeatedly traverses the machine direction axis 130, as illustrated in FIG. 6. As the line element 106 crosses the machine direction axis 130 an element angle (α) is formed. The element angle (α) is critical to achieving the desired Poisson's ratio, particularly a Poisson's ratio in the range from about 0 to about −0.60 and more preferably from about −0.20 to about −0.40. As such the element angle (α) is preferably less than about 20 degrees, such as from about 1 to about 20 degrees and more preferably from about 5 to about 15 degrees and still more preferably from about 8 to about 12 degrees.

In other embodiments the three dimensional surface pattern may be in the form of continuous linear line elements that alternate between peaks and troughs. For example, as illustrated in FIG. 7, a tissue product 100 may comprise a plurality of continuous linear line elements 160 that alternate between peaks 162 and troughs 164. The line elements 160 are generally parallel to one another and have a uniform spacing (P) there between. The line elements 160 have a width (W) and cross the machine direction axis 180 to form an element angle (α), which is preferably less than about 20 degrees, such as from about 1 to about 20 degrees and more preferably from about 5 to about 15 degrees and still more preferably from about 8 to about 12 degrees.

Referring again to FIG. 7, the portion of the tissue web 100 circumscribed by the box ABCD may be referred to as a unit cell 190 which is repeated throughout the structure. The unit cell 190 is shown separately in FIG. 7B. The unit cell 190 is comprises two parallel line elements 160, 161 having similar dimensions—width, depth and length. The line elements 160, 161 do not insect or contact one another. Rather, the line elements 160, 161 are spaced apart from one another a distance (P) which is uniform throughout the unit cell 190.

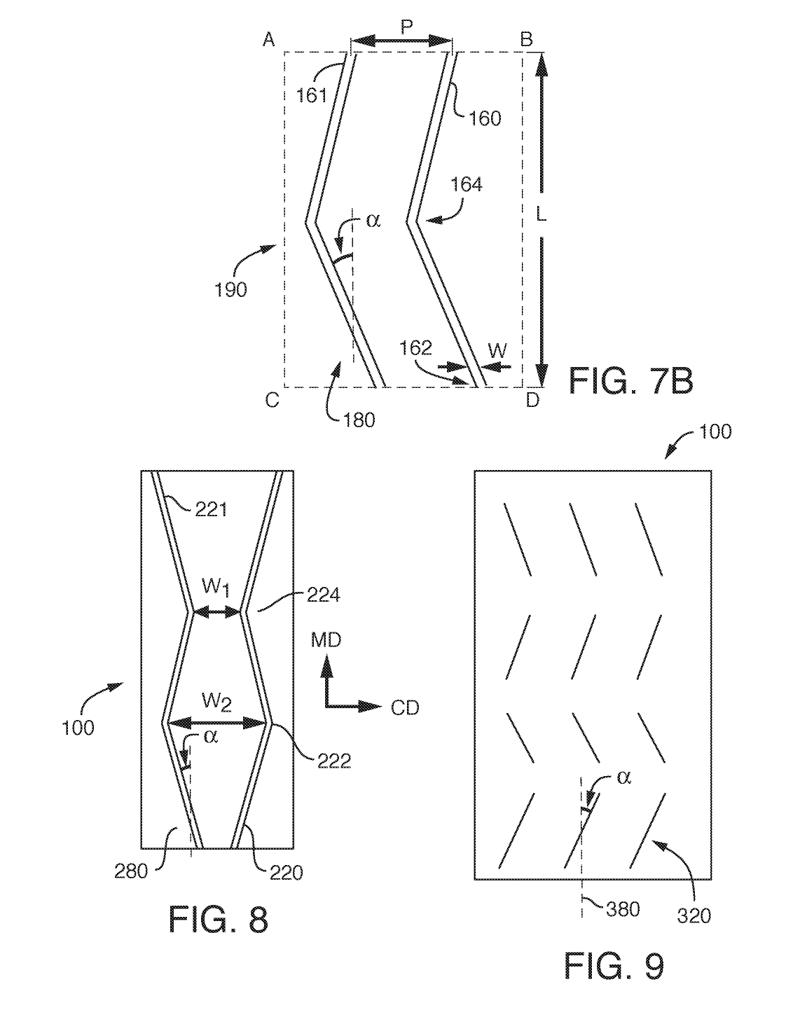

In other embodiments, such as that illustrated in FIG. 8 the patterns of adjacent elements are offset 180 degrees such that the peaks and valleys of each strand are opposite valleys and peaks respectively of each adjacent element. The pattern formed between adjacent elements 220, 221 alternates between a maximum spacing W2 when the line elements 220, 221 diverge away from each other and minimum spacing W1 when the line elements 220, 221 converge toward each other. In the tissue web 100 shown in FIG. 8, the machine direction axis 280 intersects the line element 221 at approximately the midpoint between peak and valley.

In still other embodiments, such as the tissue web 100 illustrated in FIG. 9, the three dimensional topographical pattern may be formed by a plurality of discontinuous line elements 320. The discontinuous line elements 320 generally have an element angle (α), measured at the midpoint of the element relative to the machine direction axis 380 less than about 20 degrees, such as from about 5 to about 20 degrees and more preferably from about 10 to about 15 degrees. In one embodiment, one or more of the line elements 320 may exhibit a length L of greater than about 10.0 mm, more preferably greater than about 20.0 mm and still more preferably greater than about 40.0 mm, such as from about 10.0 to about 100 mm. In one example, the line element is the result of embossing the tissue web using an embossing roll having the corresponding line element embossment. In another example, the line element is formed by molding or the like during manufacture of the tissue web and prior to substantially drying the tissue web.

In yet other embodiments, the width (w) of one or more of the line elements is less than about 5.0 mm and more preferably less than about 3.5 mm such as from about 0.5 to about 5.0 mm and more preferably from about 1.0 to about 1.5 mm. In another embodiment, the height (H) of one or more of the line elements is greater than about 0.5 mm and more preferably greater than about 0.75 mm, such as from about 0.5 to about 2 mm. Accordingly, in certain embodiments the line elements impart the tissue web, and tissue products therefrom, with a root mean square height deviation (Sq) greater than about 0.30 mm and more preferably greater than about 0.35 mm and still more preferably greater than about 0.40 mm, such as from about 0.30 to about 0.60 mm. The root mean square height deviation (Sq) is the standard deviation of the height distribution of the tissue surface, which is calculated as:

$${S}_{q} = \sqrt{\frac{1}{MN} {\sum }_{k = 0}^{M - 1} {\sum }_{i = 0}^{N - 1} {[ Z ( {x}_{k} = {y}_{i} ) ]}^{2}}$$

Measurement of the root mean square height deviation is described in the test methods section below.

In addition to imparting the tissue webs and resulting tissue products with a textured surface having an Sq greater than about 0.30 mm, the topographical pattern also imparts the tissue web and products with a negative Poisson's ratio, such as a ratio from about 0 to about −0.60 and more preferably from about −0.10 to about −0.40 and still more preferably from −0.20 to about −0.30. In particularly preferred embodiments tissue webs and products having the foregoing Poisson's ratio have a topographical pattern comprising a plurality of line elements oriented substantially in the machine direction, where the element angle (α) is less than about 20 degrees, such as from about 5 to about 20 degrees and more preferably from about 8 to about 12 degrees. Further, the line elements may be arranged such that they do not contact one another and are spaced apart from one another such that there are from about 1 to about 5 line elements per centimeter in the cross-machine direction, more preferably from about 2 to about 4 line elements per centimeter and still more preferably from about 2.5 to about 3 line elements per centimeter.

Tissue webs prepared according to the present invention may be converted into tissue products using any one of a number of well-known converting processes such as calendering, embossing and winding into rolled products. Generally the webs are converted into rolled bath tissue and towel products, which may comprise one, two or three plies where the plies may be prepared by the same process and be substantially similar or where they are prepared by different processes and have different properties. Because the web may be strained in the converting process the resulting tissue product may have a slightly higher Poisson's ratio. Accordingly, in certain embodiments the present invention provides a tissue product having a Poisson's ratio from about 0 to about −0.40, such as from about −0.10 to about −0.30. At the foregoing Poisson's ratio the tissue products also have desirable properties such as high bulk, caliper, CD Stretch and low Stiffness. For example, the tissue product may have a caliper greater than about 550 microns, such as from about 550 to about 900 microns and a basis weight greater than about 30 gsm, such as from about 30 to about 65 gsm and more preferably from about 35 to about 60 gsm. Further, the products may have a bulk greater than about 10 cc/g and more preferably greater than about 12 cc/g, such as from about 10 to about 18 cc/g.

In certain embodiments the present invention provides a tissue product having a negative Poisson's ratio and a topographical pattern comprising a plurality of substantially machine direction oriented line elements, the product in the form of a rolled bath tissue having a GMT greater than about 700 g/3″ and more preferably greater than about 750 g/3″, such as from about 700 to about 1,500 g/3″. The foregoing rolled bath tissue product may have a tensile ratio (MD Tensile (g/3″) divided by CD Tensile (g/3″)) from about 0.90 to about 3.5 and more preferably from about 1.0 to about 3.0 and still more preferable from about 1.5 to about 2.5.

In other embodiments the present invention provides a tissue product having a negative Poisson's ratio and a topographical pattern comprising a plurality of substantially machine direction oriented line elements, the tissue product in the form of a rolled paper towel product having a basis weight from about 45 to about 60 gsm and a GMT greater than about 1,500 g/3″ and more preferably greater than about 2,000 g/3″, such as from about 1,500 to about 2,500 g/3″.

In addition to the foregoing properties tissue products produced according to the present invention have good cross-machine direction properties such as stretch and tensile energy absorption, yet have relatively low stiffness. For example, in certain embodiments, the inventive provides a tissue product having a CD Stretch greater than about 8 percent, such as from about 8 to about 12 percent, a CD TEA greater than about 3.5 g*cm/cm², such as from about 3.5 to about 5.0 g*cm/cm², and a Stiffness Index less than about 6.0 and more preferably less than about 5.0.

Further, because the products have a topographical pattern on at least one surface they generally have a root mean square height deviation (Sq) greater than about 0.30 mm, and more preferably greater than about 0.32 mm, such as from about 0.30 to about 0.45 mm and more preferably from about 0.35 to about 0.40 mm.

While the surface of the webs is textured, the webs are relatively smooth to the touch such that S90 (an output of the FRT MicroSpy® Profile profilometer analysis described in the Test Methods section below) is less than about 1.0 mm, more preferably less than about 0.96 mm and still more preferably less than about 0.94 mm, such as from about 0.90 to about 1.0 mm. In a particularly preferred embodiment the invention provides a tissue product having a relatively high caliper, such as from about 575 to about 800 μm, an Sq greater than about 0.30 and an S90 less than about 0.96.

### Test Methods

### Profilometry

The surface properties of tissue webs and products prepared as described herein were measured by first generating a digital image of the fabric contacting surface of a sample using an FRT MicroSpy® Profile profilometer (FRT of America, LLC, San Jose, Calif.) and then analyzing the image using Nanovea® Ultra software version 6.2 (Nanovea Inc., Irvine, Calif.). Samples (either base sheet or finished product) were cut into squares measuring 145×145 mm. The samples were then secured to the x-y stage of the profilometer using tape, with the fabric contacting surface of the sample facing upwards, being sure that the samples were laid flat on the stage and not distorted within the profilometer field of view.

Once the sample was secured to the stage the profilometer was used to generate a three dimension height map of the sample surface. A 1602×1602 array of height values were obtained with a 30 μm spacing resulting in a 48 mm MD×48 mm CD field of view having a vertical resolution 100 nm and a lateral resolution 6 μm. The resulting height map was exported to .sdf (surface data file) format.

Individual sample .sdf files were analyzed using Nanovea® Ultra version 6.2 by performing the following functions:

(1) Using the “Thresholding” function of the Nanovea® Ultra software the raw image (also referred to as the field) is subjected to thresholding by setting the material ratio values at 0.5 to 99.5 percent such that thresholding truncates the measured heights to between the 0.5 percentile height and the 99.5 percentile height;

(2) Using the “Fill In Non-Measured Points” function of the Nanovea® Ultra software the non-measured points are filled by a smooth shape calculated from neighboring points;

(3) Using the “Filtering−Wavyness+Roughness” function of the Nanovea® Ultra software the field is spatially high pass filtered (roughness) using a Robust Gaussian Filter with a cutoff wavelength of 0.5-24.0 mm and selecting “manage end effects”;

(4) Using the “Parameter Tables” study function of the Nanovea® Ultra software ISO 25178 Values Sq (root mean square deviation, expressed in units of mm) is calculated and reported;

(5) Using the “Abbott-Firestone Curve” study function of the Nanovea® Ultra software an Abbott-Firestone Curve is generated from which “interactive mode” is selected and a histogram of the measured heights is generated, from the histogram an S90 value (95 percentile height (c2) minus the 5 percentile height (c1), expressed in units of mm) is calculated.

Based upon the foregoing, two values, indicative of surface texture are reported—Sq and S90, which all have units of mm. The units have been converted to microns for use herein.

### Tensile

Samples for tensile strength testing are prepared by cutting a 3-inch (76.2 mm)×5-inch (127 mm) long strip in either the machine direction (MD) or cross-machine direction (CD) orientation using a JDC Precision Sample Cutter (Thwing-Albert Instrument Company, Philadelphia, Pa., Model No. JDC 3-10, Ser. No. 37333). The instrument used for measuring tensile strengths is an MTS Systems Sintech 11S, Serial No. 6233. The data acquisition software is MTS TestWorks™ for Windows Ver. 4 (MTS Systems Corp., Research Triangle Park, N.C.). The load cell is selected from either a 50 or 100 Newton maximum, depending on the strength of the sample being tested, such that the majority of peak load values fall between 10 and 90 percent of the load cell's full scale value. The gauge length between jaws is 2±0.04 inches (50.8±1 mm). The jaws are operated using pneumatic-action and are rubber coated. The minimum grip face width is 3 inches (76.2 mm), and the approximate height of a jaw is 0.5 inches (12.7 mm). The crosshead speed is 10±0.4 inches/min (254±1 mm/min), and the break sensitivity is set at 65 percent. The sample is placed in the jaws of the instrument, centered both vertically and horizontally. The test is then started and ends when the specimen breaks. The peak load is recorded as either the “MD tensile strength” or the “CD tensile strength” of the specimen depending on the sample being tested. At least six (6) representative specimens are tested for each product, taken “as is,” and the arithmetic average of all individual specimen tests is either the MD or CD tensile strength for the product.

### Poisson's Ratio

A sample's Poisson's ratio was measured using a tensile testing apparatus which subjected the sample to 5 percent MD stretch at which point the change in CD width was calculated. Samples were prepared by cutting a 3″ (76.2 mm)×8.5″ (215.9 mm) long strip in the machine direction using a JDC Precision Sample Cutter (Thwing-Albert Instrument Company, Philadelphia, Pa., Model No. JDC 3-10, Ser. No. 37333). The tensile testing apparatus was a MTS Systems Sintech 11S, Serial No. 6233 and the data acquisition software was MTS TestWorks™ for Windows Ver. 4 (MTS Systems Corp., Research Triangle Park, N.C.). A 50 Newton maximum load cell was selected. The gauge length between jaws is 8±0.04 inches (203.2±1 mm). The jaws are operated using pneumatic-action and are rubber coated. The minimum grip face width is 3″ (76.2 mm), and the approximate height of a jaw is 0.5 inches (12.7 mm). The crosshead speed is 10±0.4 inches/min (254±1 mm/min), and the break sensitivity is set at 65 percent. The sample is placed in the jaws of the instrument, centered both vertically and horizontally. The sample is then stretched to 5 percent in the MD. The width in the cross-machine direction is measured at a height of 4″ (101.6 mm) above the bottom jaw. The width is measured by pressing a ruler to the sheet while supporting the back side of the sheet with another ruler. This smoothes out any wrinkles that may form due to the stretching and allows the full width of the sheet to be measured. The width is measured both before and after the sample is stretched, and the two values are used to calculate the Poisson Ratio.

$${Poissio}^{′} s Ratio = - [ \frac{( CDwidth \text{:} elongated ) - ( CDwidth \text{:} relaxed )}{( MDlength \text{:} elongated ) - ( MDlength \text{:} relaxed )} ]$$

### Examples

Base sheets were made using a through-air dried papermaking process commonly referred to as “uncreped through-air dried” (“UCTAD”) and generally described in U.S. Pat. No. 5,607,551, the contents of which are incorporated herein in a manner consistent with the present invention. Base sheets with a target bone dry basis weight of about 44 grams per square meter (gsm) were produced. The base sheets were then converted and spirally wound into rolled tissue products.

In all cases the base sheets were produced from a furnish comprising northern softwood kraft and eucalyptus kraft using a layered headbox fed by three stock chests such that the webs having three layers (two outer layers and a middle layer) were formed. The two outer layers comprised eucalyptus (each layer comprising 30 percent weight by total weight of the web) and the middle layer comprised softwood and eucalyptus. The amount of softwood and eucalyptus kraft in the middle layer was maintained for all inventive samples—the middle layered comprised 29 percent (by total weight of the web) softwood and 11 percent (by total weight of the web) eucalyptus. Strength was controlled via the addition of starch and/or by refining the furnish.

The tissue web was formed on a Voith Fabrics TissueForm V forming fabric, vacuum dewatered to approximately 25 percent consistency and then subjected to rush transfer when transferred to the transfer fabric. The transfer fabric was the fabric described as “Fred” in U.S. Pat. No. 7,611,607 (commercially available from Voith Fabrics, Appleton, Wis.).

The web was then transferred to a through-air drying fabric comprising a printed silicone pattern disposed on the sheet contacting side. The silicone formed a wave-like pattern on the sheet contacting side of the fabric. The control was prepared using the through-air drying fabric described as “Fozzie” in US Publication No. 2015/0247290 A1. The pattern properties of the control and inventive fabrics are summarized in Table 1, below.

TABLE 1

| | Element | | Element | Element | Elements |
|---|---|---|---|---|---|
| | Height | Element | Wavelength | Amplitude | Density |
| Fabric | (mm) | Angle | (mm) | (mm) | (#/cm) |
| Fozzie | 0.9 | 21.8 | 100 | 20 | 2.44 |
| Inventive | 0.8 | 11.3 | 100 | 10 | 2.44 |

Transfer to the through-drying fabric was done using vacuum levels of about 10 inches of mercury at the transfer. The web was then dried to approximately 98 percent solids before winding. Table 2 summarizes the physical properties of the base sheet webs.

TABLE 2

| | | | | | Ten- | | | Pois- |
|---|---|---|---|---|---|---|---|---|
| | | BW | Caliper | GMT | sile | Sq | S90 | son |
| Sample | Fabric | (gsm) | (microns) | (g/3″) | Ratio | (mm) | (mm) | Ratio |
| Control | Fozzie | 40.2 | 1214 | 1151 | 2.1 | 0.376 | 0.968 | −0.79 |
| Inven- | Inven- | 39.4 | 1178 | 1031 | 2.3 | 0.349 | 0.925 | −0.26 |
| tive | tive | | | | | | | |

The base sheet webs were converted into bath tissue rolls. Specifically, the base sheet was calendered using a conventional polyurethane/steel calender system comprising a 40 P&J polyurethane roll on the air side of the sheet and a standard steel roll on the fabric side. The calendered web was then converted into a rolled product comprising a single-ply. The finished products were subjected to physical analysis, which is summarized in Table 3, below.

TABLE 3

| | | Caliper | | Ten- | CD | GM | GM | Stiff- |
|---|---|---|---|---|---|---|---|---|
| | BW | (mi- | GMT | sile | Stretch | Stretch | Slope | ness |
| Sample | (gsm) | crons) | (g/3″) | Ratio | (%) | (%) | (kg) | Index |
| Control | 35.7 | 660 | 937 | 1.94 | 8.8 | 12.5 | 6.06 | 6.46 |
| Inven- | 36.9 | 598 | 805 | 2.43 | 10.8 | 13.3 | 4.82 | 5.98 |
| tive | | | | | | | | |

Accordingly, in a first embodiment the present invention provides a tissue web having a topographical pattern comprising a plurality of substantially machine direction orientated line elements disposed on at least one surface thereof, the line elements having an element angle (α) from about 1 to about 20 degrees, the tissue web having a Poisson's ratio from about 0 to about −0.60.

In a second embodiment the present invention provides the tissue web of the first embodiment wherein topographical pattern comprises from about 1 to about 4 line elements per centimeter in the cross-machine direction.

In a third embodiment the present invention provides the tissue web of the first or the second embodiment wherein the line elements have an element angle from about 8 to about 12 degrees.

In a fourth embodiment the present invention provides the tissue web of the first through the third embodiments wherein the line elements are continuous.

In a fifth embodiment the present invention provides the tissue web of the first through the fourth embodiments wherein the web has been converted into a rolled tissue product comprising a single ply and has a basis weight from about 30 to about 60 gsm and a caliper from about 700 to about 1200 microns.

In a sixth embodiment the present invention provides the tissue web of the first through the fifth embodiments wherein the web has been converted into a rolled tissue product having a GMT from about 700 to about 1,200 g/3″ and a Tensile Ratio from about 1.5 to about 2.5.

In a seventh embodiment the present invention provides the tissue web of the first through the sixth embodiments wherein the web has been converted into a rolled tissue product comprising having a CD Stretch from about 8.0 to about 12.0 percent and a Poisson's Ratio from about 0 to about −0.40.

In an eighth embodiment the present invention provides a tissue web having a topographical pattern comprising from about 2 to about 4 line elements per centimeter in the cross-machine direction, the line elements having an element angle from about 8 to about 12 degrees and the web having a Poisson's ratio from about −0.20 to about −0.40.

In a ninth embodiment the present invention provides the tissue web of the eighth embodiment wherein the line elements are continuous.

In a tenth embodiment the present invention provides the tissue web of the eighth or the ninth embodiments wherein the web has been converted into a rolled tissue product comprising a single ply and has a basis weight from about 30 to about 60 gsm and a caliper from about 700 to about 1200 microns.

In an eleventh embodiment the present invention proves the tissue web of any one of the eight through the tenth embodiments wherein the web has been converted into a rolled tissue product having a root mean square height deviation (Sq) from about 0.30 to about 0.40 mm.

In an twelfth embodiment the present invention proves the tissue web of any one of the eight through the eleventh embodiments wherein the web has been converted into a rolled tissue product having GMT from about 700 to about 1,200 g/3″ and a Tensile Ratio from about 1.5 to about 2.5.

In a thirteenth embodiment the present invention provides the tissue web of any one of the eight through the twelfth embodiments wherein the web has been converted into a rolled tissue product having CD Stretch from about 8.0 to about 12.0 percent and a Stiffness Index less from about 4.0 to about 6.0.

In a fourteenth embodiment the present invention provides the tissue web of any one of the eighth through the thirteenth embodiments wherein the web is substantially free from a bonding material.

In a fifteenth embodiment the present invention provides the tissue web of any one of the eighth through the fourteenth embodiments wherein the topographical pattern is not the result of printing a bonding material or the like.

We claim:

1. A tissue web having a machine and a cross-machine direction and a first side with a topographical pattern disposed thereon, the pattern comprising a plurality of substantially machine direction orientated line elements disposed thereon, the line elements having an element angle from about 1 to about 20 degrees, the tissue web having a Poisson's ratio from about 0 to about −0.60.

2. The tissue web of claim 1 wherein the topographical pattern comprises from about 1 to about 4 line elements per centimeter in the cross-machine direction.

3. The tissue web of claim 1 wherein the line elements have an element angle from about 8 to about 12 degrees.

4. The tissue web of claim 1 wherein the line elements are continuous.

5. The tissue web of claim 1 having a basis weight from about 30 to about 60 gsm and a caliper from about 700 to about 1200 microns.

6. The tissue web of claim 1 having a Poisson's Ratio from about −0.20 to about −0.40.

7. The tissue web of claim 1 having a CD Stretch from about 8.0 to about 12.0 percent and a Poisson's Ratio from about −0.20 to about −0.40.

8. A tissue web having a machine and a cross-machine direction and a first side with a topographical pattern disposed thereon, the pattern comprising from about 2 to about 4 line elements per centimeter in the cross-machine direction, the line elements having an element angle from about 8 to about 12 degrees and the web having a Poisson's ratio from about −0.20 to about −0.40.

9. The tissue web of claim 8 wherein the line elements are continuous and arranged parallel to one another and have an element width from about 0.5 to about 1.5 mm.

10. The tissue web of claim 8 having a basis weight from about 30 to about 60 gsm and a caliper from about 700 to about 1,200 microns.

11. The tissue web of claim 8 having a root mean square height deviation (Sq) from about 0.30 to about 0.40 mm.

12. The tissue web of claim 8 having a GMT from about 700 to about 1,200 g/3″ and a Tensile Ratio from about 1.5 to about 2.5.

13. The tissue web of claim 8 having a CD Stretch from about 8.0 to about 12.0 percent and a Stiffness Index from about 4.0 to about 6.0.

14. A tissue product comprising at least one wet-molded tissue web having a first side with a topographical pattern disposed thereon, the pattern comprising a plurality of substantially machine direction orientated line elements disposed thereon, the line elements having an element angle from about 8 to about 12 degrees and the product having a Poisson's ratio from about −0.20 to about −0.40.

15. The tissue product of claim 14 having a caliper from about 600 to about 800 μm and an Sq from about 0.30 to about 0.40 mm.

16. The tissue product of claim 14 wherein the product is a rolled bath tissue product having a GMT from about 700 to about 1,000 g/3″, a Stiffness Index from about 4.0 to about 6.0 and a CD Stretch greater than about 8.0 percent.

17. The tissue product of claim 14 wherein the product comprises at least one through-air dried ply, the tissue product having a basis weight from about 30 to about 60 gsm and a caliper from about 600 to about 1,000 μm.

18. The tissue product of claim 14 having a root mean square height deviation (Sq) from about 0.35 to about 0.40 mm and an S90 less than about 1.0 mm.

19. The tissue product of claim 14 having a Tensile Ratio from about 1.5 to about 2.5 and a bulk from about 10 to about 18 cc/g.

20. The tissue product of claim 14 wherein the product comprises a single ply through-air dried rolled bath tissue product having a basis weight from about 30 to about 50 gsm and a caliper from about 600 to about 800 μm.
